(19) United States
(12) Patent Application Publication
(10) Pub. No.: US 2007/0139871 A1
(43) Pub. Date: Jun. 21, 2007

(54) Monitor having functionality for easy assembly and disassembly

(76) Inventor: Chun-Chao Chiu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/309,889

(22) Filed: Oct. 17, 2006

(30) Foreign Application Priority Data
Oct. 17, 2005 (TW) 094136149

(51) Int. Cl. G06F 1/16; G02F 1/1333

(52) U.S. Cl. 361/681; 349/58; 248/917

(57) ABSTRACT

A monitor, which can be easily assembled and disassembled includes a display panel, a frame for supporting the display panel, and a fixing module for fixing the display panel on the frame. The fixing module includes a cover, a fixture fixed on the cover, a knob installed between the cover and the fixture in a rotatable manner, slidable rods positioned on the fixture in a slidable manner for sliding into fixing holes on the display panel so as to lock the display panel with the frame, and an arm fixed on the knob for ejecting the slidable rods from the fixing holes when the arm rotates to a first position. The structure of the monitor is much simpler and has less components thus the assembly of the monitor becomes quick and easy.

### BACKGROUND OF THE INVENTION

1. Field of the Invention

The present invention relates to a monitor, more particularly to a monitor, which can be easily assembled and disassembled.

2. Description of the Prior Art

The current flat screen monitor available on the market, such as an LCD panel or a plasma display panel, is a lighter and thinner monitor in comparison with the conventional CRT monitor. In recent development, cost of manufacturing a flat screen monitor has dropped tremendously; subsequently the retail price of a flat screen monitor has also dropped. As a result, the flat screen monitors are more commonly used and more affordable for families.

The current size of the flat screen monitor varies from 10 inches to above 40 inches. Regarding to the assembly of the flat screen monitor, flat screen monitor below 19 inches utilizes a screw to fix and hold a display panel on a support base. Flat screen monitors above 20 inches utilize a metal component inserted into a back cover of the display panel and then covered by an outer plastic casing for design and decoration. However, the assembly method of the above mentioned is not only complicated but also utilizes very tiny components, hence there is an increase in labor and time on the production line and this associates to increases in the cost of manufacturing.

Furthermore, if the architecture of the flat screen monitor is complicated, or if the architecture contains more small components utilized in assembly, then the flat screen monitor packaging must be sufficiently large to contain all the components of the product. As a result, the product packaging is big, relatively it takes up more space, so during each delivery, there can be only a certain amount of goods delivered hence this also increases the freight cost when said LCD panels are involved.

### SUMMARY OF THE INVENTION

According to the present invention, a monitor that can be easily assembled comprises a display panel, a frame for supporting the display panel, and a fixing module for fixing the display panel on the frame. The display panel has two fixing holes. The fixing module comprises a cover, a fixture fixed on the cover, a knob installed between the cover and the fixture in a rotatable manner, and two slidable rods positioned on the fixture in a slidable manner for sliding into the fixing holes respectively on the display panel so as to lock the display panel with the frame. The slidable rods have protrusions. The fixing module further comprises an arm fixed on the knob for engaging with the protrusions of the slidable rods so as to eject the slidable rods out of the fixing holes when the arm rotates to a first position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a monitor according to the present invention.

FIG. 2 illustrates a detailed illustration of the monitor of FIG. 1.

FIG. 3 illustrates a detailed illustration of the fixing module of FIG. 1.

FIG. 4 illustrates an assembly diagram of the fixing module of FIG. 3.

FIG. 5 illustrates a diagram of the fixing module of FIG. 1 fixing the display panel on the frame.

FIG. 6 illustrates a diagram of the slidable rod of FIG. 5 sliding into a fixing hole of the display panel.

### DETAILED DESCRIPTION

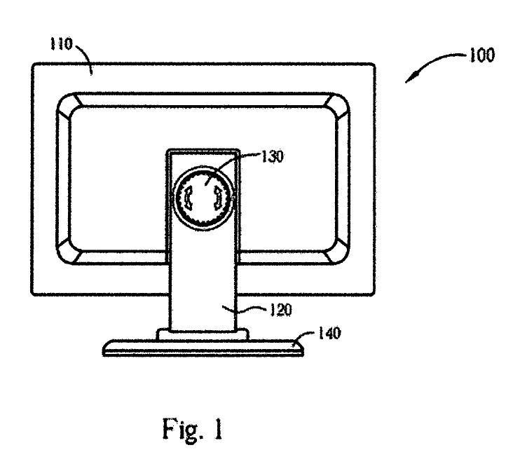

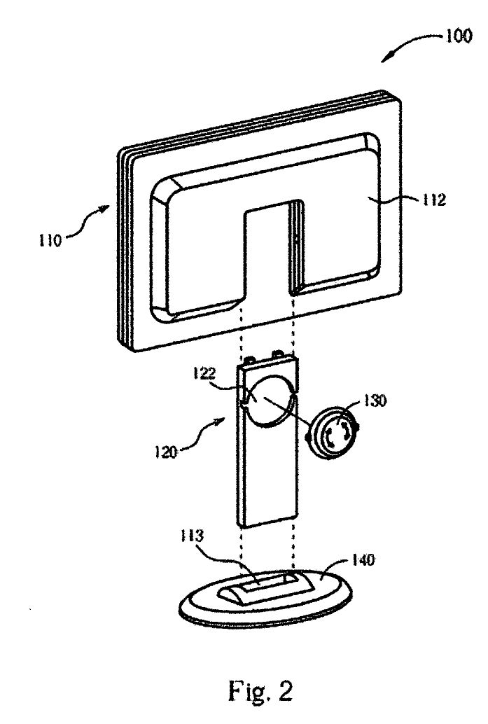

Please refer to FIG. 1. FIG. 1 illustrates a diagram of a monitor 100 according to the present invention. The monitor 100 includes a display panel 10, a frame 120 for supporting the display panel 110, and a fixing module 130 for fixing the display panel 110 on the frame 120. The monitor 100 further includes a base 140 for supporting the frame 120, hence the monitor 100 is constructed from the four said components of the above-mentioned. However, in another embodiment of the present invention, the frame 120 and the base 140 can combine as a single component, which means that the frame 120 can allow the monitor to stand on a flat surface, thus the monitor only requires three components. Please refer to FIG. 2. FIG. 2 illustrates a detailed illustration of the monitor 100 of FIG. 1. When assembling the monitor 100, the frame 120 is first inserted into grooves at a back cover 112 of the display panel 110, then the fixing module 130 is installed into a hole 122 on top of the frame 120, thus the display panel 110 is fixed on the frame 120, lastly the frame 120 is inserted into a concave slot 113 of the base 140 such that the monitor 100 can stand upright, in this way a screw driver or other complicated tool is not required to assemble the monitor 100, and assembling the monitor 100 of the present invention is quick and easy.

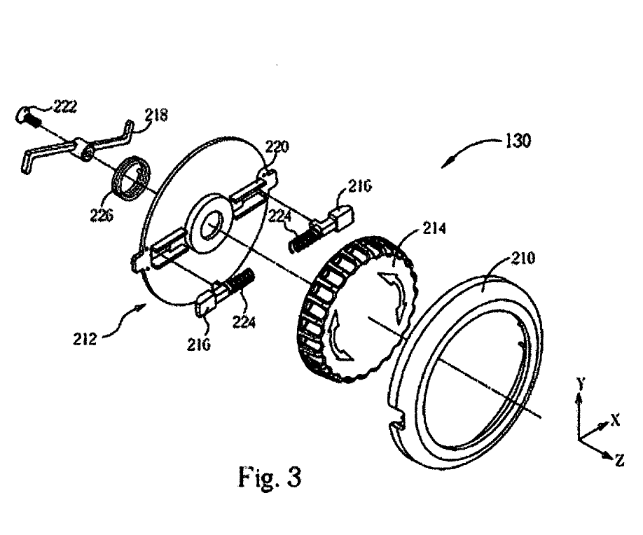

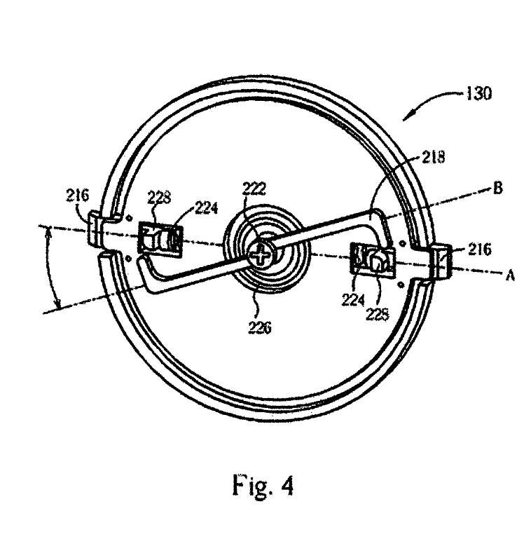

Please refer to FIG. 3 and FIG. 4. FIG. 3 illustrates a detailed illustration of the fixing module 130 of FIG. 1. FIG. 4 illustrates an assembly diagram of the fixing module 130 of FIG. 3. As illustrated in FIG. 3, the fixing module 130 includes a cover 210, a fixture 212, a knob 214, two slidable rods 216, and an arm 218. The slidable rod 216 is fixed and moves on the fixture 212 in a sliding manner. A guiding structure 220 is installed on the fixture 212 for controlling operation of a Y axis direction of the slidable rod 216, as the slidable rod 216 is installed between the fixture 212 and the knob 214, operation of a Z axis direction of the slidable rod 216 is being controlled, therefore the slidable rod 216 can only slide along the X axis direction. However, in the present invention, the guiding structure 220 can be replaced with any structure which can refrain the slidable rod 216 from moving along the Y axis and Z axis directions such that the slidable rod 216 can only slide along the X axis direction. The knob 214 is fixed between the cover 210 and the fixture 212 in a rotatable manner, and a middle portion of the arm 218 passes through the fixture 212 and a screw 222 is utilized to fix the arm 218 on the knob 214 so that the arm 218 is rotatable with the knob 214. In another embodiment, the arm 218 can be fixed on the knob 214 by utilizing its original structure or other methods. The fixing module 130 further includes two compression springs 224 and a torsion spring 226. The compression springs 224 are utilized to push the slidable rods 216 to protrude from the fixing module 130, and the torsion spring 226 is utilized to rotate the arm 218 to a predetermined position. As shown in FIG. 4, after the fixing module 130 is assembled, the slidable rods 216 protrude from the fixing module 130 due to the drive of the compression springs 224, and the arm 218 rotates to a second position B from a first position A. When the knob 214 is rotated such that the arm 218 rotates in a counterclockwise direction to the first position. A, the arm 218 will hook itself onto convex structures 228 of the slidable rods 216 and thereby drive the slidable rods 216 to retract inwards. Alternately, when the knob 214 is released, the arm 218 will be driven back to the second position B by the torsion spring 226, and the slidable rods 216 will again protrude from the fixing module 130 due to the drive of the compression springs 224.

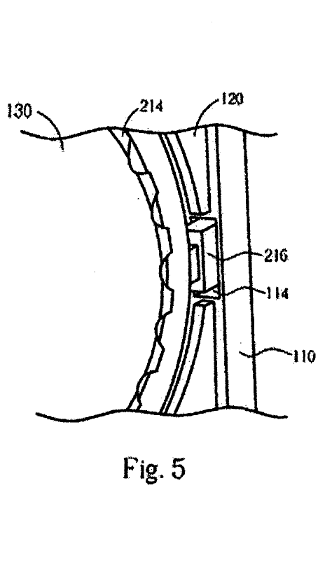

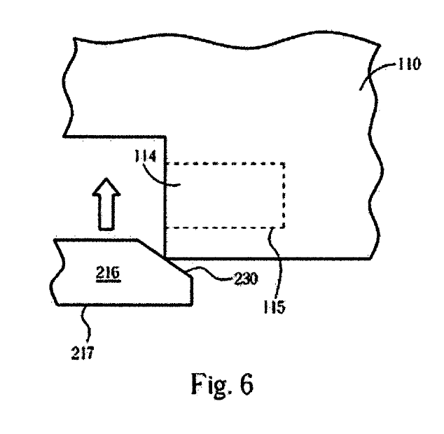

Please refer to FIG. 5 and FIG. 6. FIG. 5 illustrates a diagram of the fixing module 130 of FIG. 1 fixing the display panel 110 on the frame 120. FIG. 6 illustrates a diagram of the slidable rod 216 of FIG. 5 sliding into a fixing hole 114 of the display panel 110. As shown in FIG. 5, when the slidable rods 216 of the fixing module 130 slides into the fixing hole 114 of the display panel 110 due to the drive of the compression spring 224, the display panel 110 is fastened onto the frame 120. As mentioned previously, as the display panel 110 is being dissembled, the knob 214 of the fixing module 130 is being rotated so that the arm 218 rotates to the first position A, then the arm 218 will hook itself onto the convex structures 228 of the slidable rods 216 and drive the slidable rods 216 to retract inwards so that the slidable rods 216 are ejected from the fixing hole 114, next the display panel 110 can be released when the fixing module 130 is removed. Furthermore, in FIG. 6, the slidable rod 216 of the fixing module 130 includes a slanting surface 230. When the fixing module 130 is being pushed into the display panel 110, the slidable rod 216 moves inwards due to drive of the display panel 110 on the slanting surface 230 of the slidable rod 216. When a rear side 217 of the slidable rod 216 moves to be at the same level as a rear side 115 of the fixing hole 114, the slidable rod 216 slides into the fixing hole 114 due to the drive of the compression spring 224 exerted on the slidable rod 216 to lock the display panel 110 on the frame 120. However, in another embodiment, the slanting surface 230 of the slidable rod 216 can be replaced with a curved surface for engaging with the display panel 110.

In conclusion, the present invention provides a monitor which is easily assembled and disassembled. When the display panel 110 is to be locked on the frame 120, the frame 120 is first inserted within the grooves at the back cover 112 of the display panel 110, then the fixing module 130 is pushed into the display panel 110, hence the display panel 110 is locked on the frame 120. When the display panel is to be released, all that is required is to rotate the knob 214 to move the arm 218 to the first position A, then the slidable rods 216 are ejected from the fixing holes 114 and the display panel 110 is released. Thus, the monitor 100 of the present invention can be assembled and dissembled easily and quickly without requiring a screwdriver or other complex tool. Additionally, the monitor 100 has fewer components therefore the packaging of the product is smaller and takes up less space, so relatively the cost of freight can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A monitor that can be easily assembled comprising:
a display panel, the display panel having two fixing holes;
a frame for supporting the display panel; and
a fixing module for fixing the display panel on the frame, the fixing module comprising:
a cover;
a fixture fixed on the cover;
a knob installed between the cover and the fixture in a rotatable manner;
two slidable rods positioned on the fixture in a slidable manner for sliding into the fixing holes respectively on the display panel so as to lock the display panel with the frame, the slidable rods having protrusions; and
an arm fixed on the knob for engaging with the protrusions of the slidable rods so as to eject the slidable rods out of the fixing holes when the arm rotates to a first position.

2. The monitor of claim 1 further comprising a base for supporting the frame.

3. The monitor of claim 1 wherein the fixing module further comprises two compression springs for pushing the slidable rods towards the fixing holes.

4. The monitor of claim 1 wherein the fixing module further comprises a torsion spring for rotating the arm to a second position to disengage with the protrusions of the slidable rods so that the slidable rods are able to slide into the fixing holes.

5. The monitor of claim 1 wherein the display panel is an LCD panel.

6. A fixing module of a monitor, the monitor also having a display and a frame, the fixing module being for fixing the display panel on the frame, the display panel having fixing holes, the fixing module comprising:
a cover;
a fixture fixed on the cover;
a knob installed between the cover and the fixture in a rotatable manner;
slidable rods positioned on the fixture in a slidable manner for sliding into the fixing holes on the display panel so as to lock the display panel with the frame, the slidable rods having protrusions; and
an arm fixed on the knob for engaging with the protrusions of the slidable rods so as to eject the slidable rods out of the fixing holes when the arm rotates to a first position.

7. The fixing module of claim 6 further comprising compression springs for pushing the slidable rods towards the fixing holes.

8. The fixing module of claim 6 further comprising a torsion spring for rotating the arm to a second position to disengage with the protrusions of the slidable rods so that the slidable rods are able to slide into the fixing holes.

9. The fixing module of claim 6 wherein the display panel is an LCD panel.
